(19) United States
(12) Patent Application Publication
(10) Pub. No.: US 2022/0309033 A1
(43) Pub. Date: Sep. 29, 2022

(54) INFORMATION PROCESSING SYSTEM, INFORMATION PROCESSING METHOD, AND NON-TRANSITORY COMPUTER READABLE MEDIUM STORING PROGRAM

(71) Applicant: FUJIFILM Business Innovation Corp., Tokyo (JP)

(72) Inventor: Jiali GU, Kanagawa (JP)

(73) Assignee: FUJIFILM Business Innovation Corp., Tokyo (JP)

(21) Appl. No.: 17/400,134

(22) Filed: Aug. 12, 2021

(30) Foreign Application Priority Data
Mar. 25, 2021 (JP) 2021-052347

(51) Int. Cl. G06F 16/11; G06F 16/93; H04L 29/08; G06K 9/00

(52) U.S. Cl. CPC G06F 16/116; G06F 16/93; H04L 67/06; G06K 9/00469

(57) ABSTRACT

An information processing system includes a server apparatus that processes a document, and a client apparatus that provides a user with a result of processing the document, in which processing of the document is performed in the server apparatus and the client apparatus in response to an instruction from the user, in a case where the processing of the document in the client apparatus is completed faster than the processing of the document in the server apparatus, a result of the processing of the document is transmitted from the client apparatus to the server apparatus, and in a case where an instruction for the document is given by another client apparatus different from the client apparatus, the result of the processing of the document is transmitted from the server apparatus to the other client apparatus.

### CROSS-REFERENCE TO RELATED APPLICATIONS

This application is based on and claims priority under 35 USC 119 from Japanese Patent Application No. 2021-052347 filed Mar. 25, 2021.

### BACKGROUND

### (i) Technical Field

The present invention relates to an information processing system, and information processing method, and a non-transitory computer readable medium storing a program.

### (ii) Related Art

JP4835612B discloses a configuration in which, in a method of converting an electronic document into a still image by using a service server on a network and outputting the still image, a page to be converted is selected from an electronic document based on a viewing tendency for the electronic document, and efficient conversion is provided.

JP4804558B discloses a configuration in which, in a case where data in which still images and moving images are mixed is collectively uploaded from a camera to a data storage system, a representative still image is acquired based on the still images forming the moving image, and an information corresponding to an exchangeable image file format of the moving image is embedded in the representative still image and updated in the same manner as in a still image such that it is not necessary for the data storage system side to perform a process of creating the representative still image from the moving image.

### SUMMARY

In a case where a client apparatus obtains a processing result of a document, generally, the client apparatus requests the processing result to a server apparatus and obtains the processing result therefrom. However, a waiting time may occur in the client apparatus due to a delay in, for example, a conversion process by the server apparatus. In contrast, the client apparatus processes a document, and thus the time for obtaining a processing result can be shortened. However, in this case, since work of obtaining the processing result is completed only by the client apparatus, in a case where the same process is repeated by another client apparatus, the efficiency of document processing as a whole system is poor.

Aspects of non-limiting embodiments of the present disclosure relate to an information processing system and a non-transitory computer readable medium storing a program that can share a processing result with other client apparatuses in a case where the processing result of a document is obtained by a client apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a server apparatus that processes a document; and a client apparatus that provides a user with a result of processing the document, in which processing of the document is performed in the server apparatus and the client apparatus in response to an instruction from the user, in a case where the processing of the document in the client apparatus is completed faster than the processing of the document in the server apparatus, a result of the processing of the document is transmitted from the client apparatus to the server apparatus, and in a case where an instruction for the document is given by another client apparatus different from the client apparatus, the result of the processing of the document is transmitted from the server apparatus to the other client apparatus.

### BRIEF DESCRIPTION OF THE DRAWINGS

Exemplary embodiment(s) of the present invention will be described in detail based on the following figures, wherein:

FIG. 1 is a diagram showing an overall configuration example of an information processing system to which the present exemplary embodiment is applied;

FIG. 2 is a block diagram showing an example of a hardware configuration of a server apparatus according to the present exemplary embodiment;

FIG. 3 is a block diagram showing an example of a hardware configuration of a client apparatus according to the present exemplary embodiment;

FIG. 4 is a diagram showing an example of display of an operation screen to which the present exemplary embodiment is applied;

FIG. 5 is a block diagram showing an example of a functional configuration of a server apparatus according to the present exemplary embodiment;

FIG. 6 is a block diagram showing an example of a functional configuration of the client apparatus according to the present exemplary embodiment;

FIG. 7 is a flowchart showing a process procedure in which the server apparatus according to the present exemplary embodiment manages a document;

FIG. 8 is a flowchart showing a process procedure in the client apparatus according to the present exemplary embodiment displays a document; and

FIG. 9 is a diagram showing an example of a screen for receiving settings related to document processing in the client apparatus according to the present exemplary embodiment.

### DETAILED DESCRIPTION

Overall Configuration of Information Processing System 1

Hereinafter, an exemplary embodiment of the present invention will be described in detail with reference to the accompanying drawings.

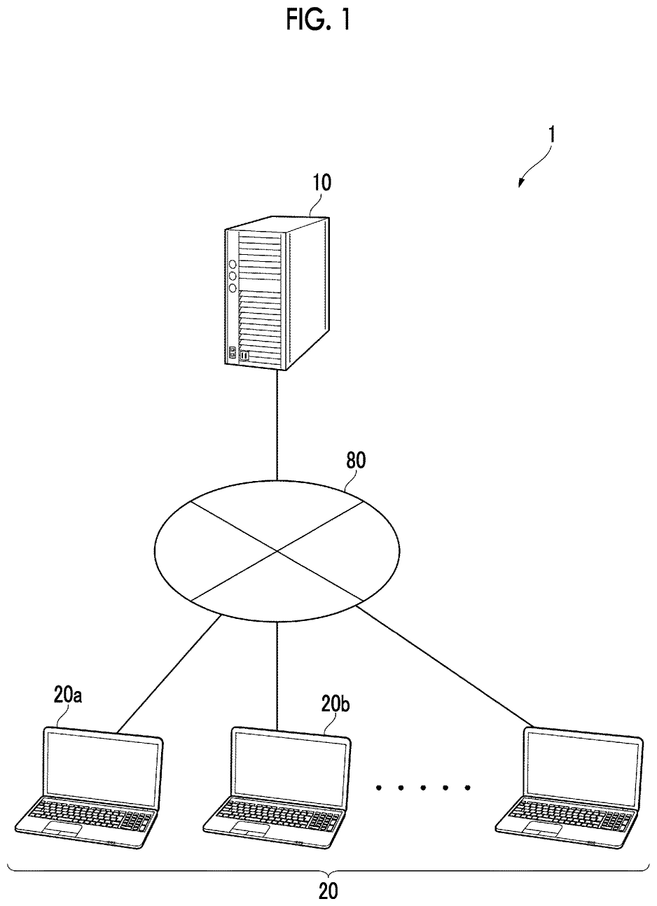

FIG. 1 is a diagram showing an overall configuration example of an information processing system 1 to which the present exemplary embodiment is applied.

As shown in the figure, in the information processing system 1 includes a server apparatus 10 that processes a document and a plurality of client apparatuses 20 (20a, 20b, . . . ) that provide a document processing result to a user, which are connected to each other via a communication line 80. The communication line 80 is a line such as the Internet, and is used for information communication between the server apparatus 10 and the client apparatus 20.

In the present exemplary embodiment, the “document” is an electronic document stored in the server apparatus 10 or the like. Document data of the document includes image information used in a case of converting an electronic document into an image, and attribute information such as the update date and time of the electronic document, a paper size, the number of pages, and keywords in the document.

The server apparatus 10 is an apparatus that provides a service to a user via the client apparatus 20 in response to a request sent from the client apparatus 20 through the user's operation. As this service, the server apparatus 10 in the present exemplary embodiment manages the document data provided by the client apparatus 20, a document processing result, and the like.

The client apparatus 20 is an image display apparatus used by a user who uses the information processing system 1. The client apparatus 20 in the present exemplary embodiment provides a document processing result to the user in accordance with an instruction from the user. Examples of the client apparatus 20 include a personal computer, a tablet terminal, and a smartphone.

Hardware Configuration of Server Apparatus 10

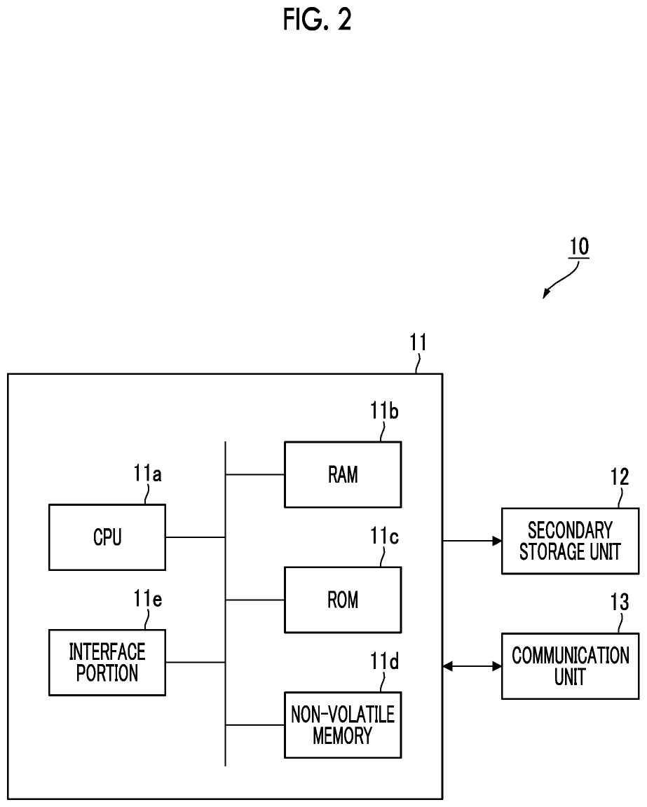

FIG. 2 is a diagram showing a hardware configuration example of the server apparatus 10 according to the present exemplary embodiment.

The server apparatus 10 according to the present exemplary embodiment includes a calculation processing unit 11 that executes a digital calculation process according to a predefined management program in a case of managing documents, a secondary storage unit 12 that is realized by, for example, a hard disk drive (HDD) and records document data, document processing results, and the like, and a communication unit 13 that transmits and receives information via the communication line 80.

The calculation processing unit 11 includes a CPU 11a as an example of a processor that controls the entire apparatus, a RAM 11b that is used as a work memory of the CPU 11a, and a ROM 11c that stores a document management program or the like executed by the CPU 11a. The calculation processing unit 11 includes a non-volatile memory 11d that is rewritable and capable of storing data even in a case where the power supply is interrupted, and an interface portion 11e that controls each unit such as the communication unit 13 connected to the calculation processing unit 11. The non-volatile memory 11d is configured with, for example, an SRAM or a flash memory backed up by a battery, and stores a document processing result or the like displayed on the client apparatus 20. The secondary storage unit 12 stores the document data, the document processing result, and the like, and also stores a document management program executed by the calculation processing unit 11. The calculation processing unit 11 reads the document management program stored in the secondary storage unit 12, and thus each process in the server apparatus 10 of the present exemplary embodiment is executed.

Hardware Configuration of Client Apparatus 20

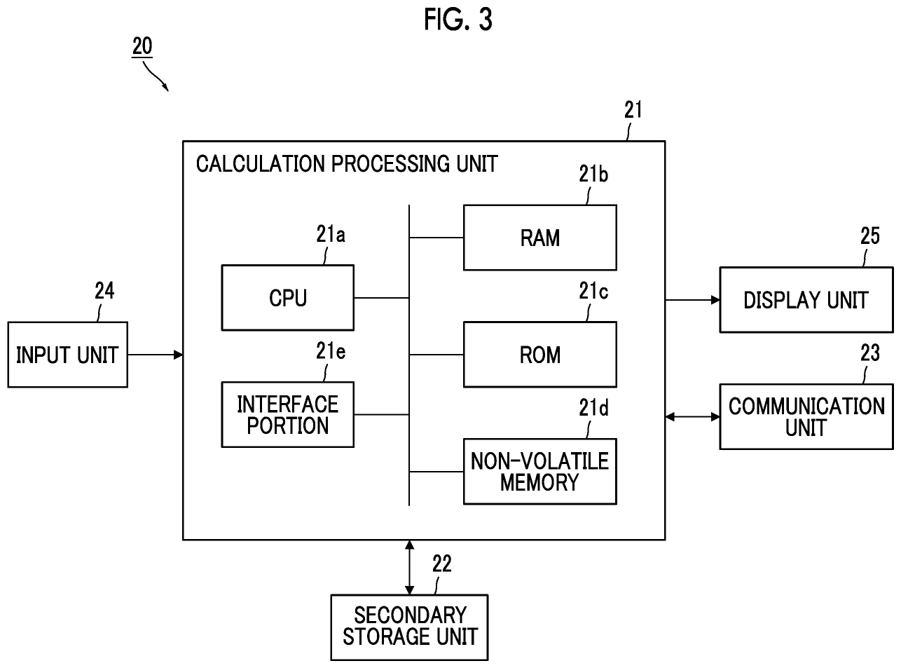

FIG. 3 is a block diagram showing an example of a hardware configuration of the client apparatus 20 according to the present exemplary embodiment. The client apparatus 20 according to the present exemplary embodiment includes a calculation processing unit 21 that executes a digital calculation process according to a predefined processing program in a case of displaying an image, a secondary storage unit 22 that is realized by, for example, a hard disk drive (HDD) and records document data, document processing results, and the like, and a communication unit 23 that transmits and receives information via the communication line 80. The client apparatus 20 includes an input unit 24 such as a keyboard, a pointing device, and a touch panel that receive input operations from a user, and a display unit 25 including a liquid crystal display panel or an organic electroluminescence (EL) display panel that displays images, text information, or the like to the user.

The calculation processing unit 21 includes a CPU 21a as an example of a processor that controls the entire apparatus, a RAM 21b that is used as a work memory of the CPU 21a, and a ROM 21c that stores an image display processing program or the like executed by the CPU 21a. The calculation processing unit 21 includes a non-volatile memory 21d that is rewritable and capable of storing data even in a case where the power supply is interrupted, and an interface portion 21e that controls each unit such as the input unit 24 connected to the calculation processing unit 21. The non-volatile memory 21d is configured with, for example, an SRAM or a flash memory backed up by a battery, and stores a document processing result displayed on the display unit 25. The secondary storage unit 22 stores the document data, the document processing result, and the like, and also stores an image display processing program executed by the calculation processing unit 21. The calculation processing unit 21 reads the image display processing program stored in the secondary storage unit 22, and thus each process in the client apparatus 20 of the present exemplary embodiment is executed.

Here, programs executed by the CPUs 11a and 21a as an example of a processor may be provided to the calculation processing units 11 and 21 in a state of being stored in a computer readable recording medium such as a magnetic recording medium (a magnetic tape, a magnetic disk, or the like), an optical recording medium (an optical disc or the like), a magnetooptical recording medium, or a semiconductor memory. The programs executed by the CPUs 11a and 21a may be downloaded to the server apparatus 10 and the client apparatus 20 by using communication means such as the Internet.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

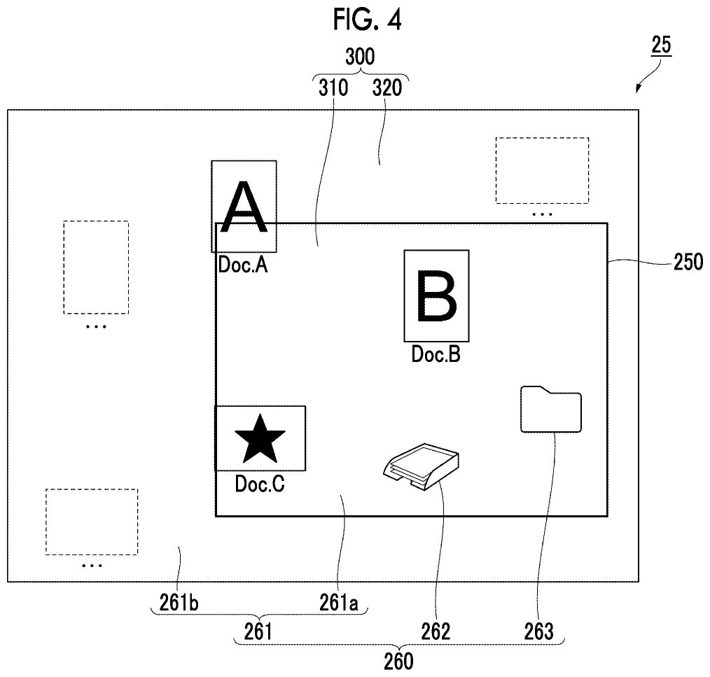

FIG. 4 is a diagram showing an example of display of an operation screen 250 to which the present exemplary embodiment is applied.

The display unit 25 has the operation screen 250 that displays at least a part of a region of a workspace 300 on so-called file handling software and receives a user's operation. The file handling software is software that digitizes and manages document data, and has a function of promoting centralized management of paper and electronic data. The workspace 300 is a region in which an instruction image or the like for receiving a user's instruction for a document is arranged.

In the workspace 300, a region actually displayed on the operation screen 250 is referred to as a display region 310, and a region not actually displayed on the operation screen 250 is referred to as a non-display region 320. In the workspace 300, “the display region 310” or “the non-display region 320” is assumed to be changed by a user's operation, for example, a scroll operation. A scroll image indicating “which region is set as the display region 310” in the workspace 300 by receiving a scroll operation from the user may be displayed on the operation screen 250.

In addition to icons 260, a menu image, a toolbar, or the like (not shown) may be displayed on the operation screen 250. The icons 260 are examples of instruction images for receiving a user's instruction for a document. The menu image is an image for receiving a user's operation on a document image related to a document. The toolbar is a collection of instruction portions provided to simplify user's operations on electronic documents. Examples of the operations on electronic documents include an operation for saving, printing, rotating, searching, and encrypting an electronic document, and an operation for bundling two or more electronic documents.

The icons 260 represent various functions such as a program function with pictograms, and are instruction images for receiving a user's instruction for a document. In the example shown in FIG. 4, as examples of the icons 260, a document icon 261 for selecting an electronic document, a tray icon 262 for selecting a tray used for a user to deliver electronic documents to a third party, and an electronic document, and a folder icon 263 for selecting a folder used for storing documents are shown.

The document icon 261 is a thumbnail image for checking at least a part of details of a file managed by the file handling software. For example, in a case where a corresponding file is image data, the thumbnail image is displayed as a reduced image of an original image. In a case where the corresponding file is document data of a plurality of pages, a representative page such as a first page is displayed as a reduced image. The document icon 261 displayed as a thumbnail image functions as an icon for opening the corresponding file. In the present exemplary embodiment, the document icon 261 actually displayed on the operation screen 250 is referred to as a display document icon 261a, and the document icon 261 not actually displayed is referred to as a non-display document icon 261b.

The operation screen 250 has an aspect of displaying a document image related to a document stored in the corresponding file according to a user's instruction for the tray icon 262 or the folder icon 263. In this aspect, in a case where an instruction for the tray icon 262 or the folder icon 263 is given, a document image may be displayed by the document icon 261 such as a thumbnail image.

A thumbnail image of the icon 260 or the like for which an instruction is given from the user may be enlarged on the operation screen 250 to a size sufficient to understand details of a document and displayed without starting a new program. Generally, the thumbnail image is displayed larger than the corresponding icon 260. There is an aspect in which a resolution of the enlarged thumbnail image may be higher than a resolution of a thumbnail image displayed as the icon 260.

Functional Configuration of Server Apparatus 10

Next, a functional configuration of the server apparatus 10 will be described.

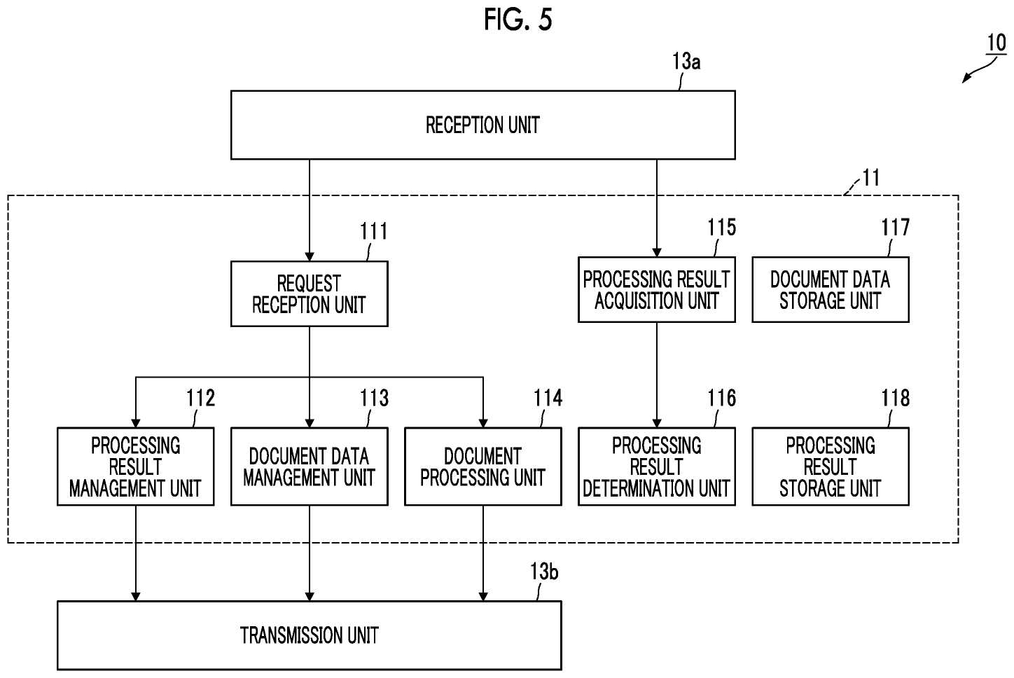

FIG. 5 is a block diagram showing an example of a functional configuration of the server apparatus 10. The server apparatus 10 includes a request reception unit 111, a processing result management unit 112, a document data management unit 113, a document processing unit 114, a processing result acquisition unit 115, a processing result determination unit 116, a document data storage unit 117, and a processing result storage unit 118, realized by the calculation processing unit 11 shown in FIG. 2. In FIG. 5, the communication unit 13 shown in FIG. 2 is separated into a reception unit 13a that receives a request or a document processing result from the client apparatus 20 and a transmission unit 13b that transmits document data or a document processing result according to functions thereof.

The request reception unit 111 acquires and receives a request from information that is transmitted from the client apparatus 20 and received by the reception unit 13a in response to a user's instruction. More specifically, the request reception unit 111 receives a request for providing a result of processing a document to be displayed on the display unit 25 of the client apparatus 20, document data necessary for processing the document, and the like.

The processing result management unit 112 retrieves whether or not the requested document processing result is stored in the processing result storage unit 118 based on the request received by the request reception unit 111. In a case where the requested document processing result is stored, the processing result management unit 112 extracts the requested document processing result from the processing result storage unit 118, and transmits the requested document processing result to the client apparatus 20 that has made the request via the transmission unit 13b.

The document data management unit 113 retrieves whether or not the requested document data is stored in the document data storage unit 117 based on the request received by the request reception unit 111. In a case where the requested document data is stored, the processing result management unit 112 extracts the requested document data from the document data storage unit 117 and transmits the requested document data to the client apparatus 20 that has made the request via the transmission unit 13b.

The document processing unit 114 extracts the requested document data from the document data storage unit 117 and processes the document data based on the request received by the request reception unit 111. More specifically, the document processing unit 114 performs a process of converting image information included in the document data into a viewable format on the display unit 25. Examples of the viewable format include a thumbnail image. For example, the document processing unit 114 performs a process of extracting attribute information from the document data. A document processing result in the document processing unit 114 is transmitted to the client apparatus 20 that has made the request via the transmission unit 13b, and is also acquired by the processing result storage unit 118.

The processing result acquisition unit 115 acquires a document processing result in the client apparatus 20 from information that is transmitted from the client apparatus 20 and received by the reception unit 13a. More specifically, the processing result acquisition unit 115 acquires a processing result of a document of which processing has not been completed by the document processing unit 114.

The processing result determination unit 116 determines whether or not the document processing result in the client apparatus 20 acquired by the processing result acquisition unit 115 is appropriate to be stored in the server apparatus and satisfies, for example, a predefined condition. More specifically, the processing result determination unit 116 determines whether or not a document processing result completed earlier than in the server apparatus satisfies a predefined accuracy and is highly accurate, in other words, the accuracy is high. For example, in a case where the processing result determination unit 116 acquires processing results of the same document from two or more client apparatuses 20, the processing result determination unit 116 compares the processing results in the client apparatuses 20 and determines whether or not the predefined accuracy is satisfied. Ina case where the processing results in the two or more client apparatuses 20 match each other, it is determined that a predefined processing accuracy is satisfied. The processing result determination unit 116 may compare the accuracy of the document processing result in the client apparatus 20 acquired by the processing result acquisition unit 115 with the accuracy of the document processing result in the document processing unit 114, and determine whether or not the predefined processing accuracy is satisfied.

The document data storage unit 117 acquires and stores document data from information that is transmitted from the client apparatus 20 and received by the reception unit 13a. The document data storage unit 117 is realized by the non-volatile memory 11d.

The processing result storage unit 118 acquires and stores the processing result of the document processed by the document processing unit 114 and the processing result of the document processed by the client apparatus 20 determined by the processing result determination unit 116. The processing result storage unit 118 is realized by the non-volatile memory 11d.

Functional Configuration of Client Apparatus 20

Next, a functional configuration of the client apparatus 20 will be described.

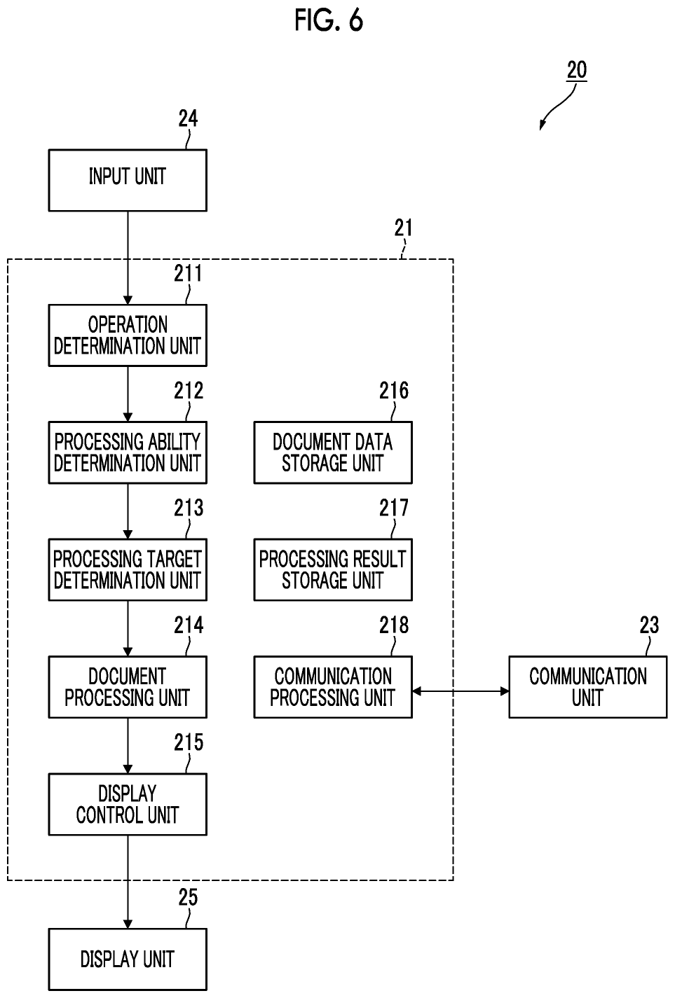

FIG. 6 is a block diagram showing an example of a functional configuration of the client apparatus 20. The client apparatus 20 includes an operation determination unit 211, a processing ability determination unit 212, a processing target determination unit 213, a document processing unit 214, a display control unit 215, a document data storage unit 216, a processing result storage unit 217, and a communication processing unit 218, realized by the calculation processing unit 21 shown in FIG. 3.

The operation determination unit 211 determines whether or not a user operation has been performed on the operation screen 250 via the input unit 24 (refer to FIG. 4). The user operation is, for example, an operation for designating an image, various icons, a position, and the like on the operation screen 400, a scroll operation, a key input operation, and the like.

The processing ability determination unit 212 determines whether or not the client apparatus is capable of processing a document for which display is requested based on details determined by the operation determination unit 211. More specifically, the processing ability determination unit 212 determines whether or not to process the document based on a configuration, a setting, and a usage status for the client apparatus. The configuration of the client apparatus includes, for example, the type of the client apparatus such as a personal computer or a smartphone, an operating system (OS), and the presence or absence of processing ability. The setting of the client apparatus includes a setting of whether or not a process is performed by the user, a setting of ability of a process performed by the user, and the like.

The processing target determination unit 213 determines whether or not a document processing target in the client apparatus is a document displayed on the display unit 25 through the user's operation. In other words, the processing target determination unit 213 determines whether or not the document processing target in the client apparatus is a document in the display region 310.

The document processing unit 214 extracts and processes document data corresponding to the document processing target in the client apparatus from the document data storage unit 216 based on details determined by the processing target determination unit 213. More specifically, the document processing unit 214 performs a process of converting image information included in the document data into a format that can be viewed on the display unit 25. Examples of the viewable format include a thumbnail image. For example, the document processing unit 214 performs a process of extracting attribute information from the document data.

The display control unit 215 controls a display aspect or a position of the document icon 261 (refer to FIG. 4) or the like selected by the user based on a document processing result acquired from the document processing unit 214, the processing result storage unit 217, or the communication processing unit 218, or display on the operation screen 250.

The document data storage unit 216 acquires and stores document data from the secondary storage unit 22 or the communication processing unit 218. The document data storage unit 216 is realized by the non-volatile memory 21d.

The processing result storage unit 217 acquires and stores document processing results from the secondary storage unit 22, the document processing unit 214, and the communication processing unit 218. The processing result storage unit 217 is realized by the non-volatile memory 21d.

The communication processing unit 218 processes information transmitted or received by the communication unit 23.

The communication processing unit 218 acquires the details determined by the processing ability determination unit 212 or the details controlled by the display control unit 215, and extracts the presence of necessary document data or a document processing result that is not stored in the client apparatus. The communication processing unit 218 requests extracted document data or document processing result to the server apparatus 10 and a separate apparatus different from the server apparatus 10 via the communication unit 23. The communication processing unit 218 acquires the document data, the document processing result, and the like from the server apparatus 10 or the separate apparatus different from the server apparatus 10 via the communication unit 23, and provides information required by the document processing unit 214, the display control unit 215, the document data storage unit 216, the processing result storage unit 217, and the like. In other words, the communication processing unit 218 processes and determines the acquired information.

Document Management Process in Server Apparatus 10

Next, document management of the server apparatus 10 will be described with reference to FIGS. 2, 5, and 7. Here, as an example, a case is assumed in which a request for image information of a document storing document data in the server apparatus 10 is received from the client apparatus 20.

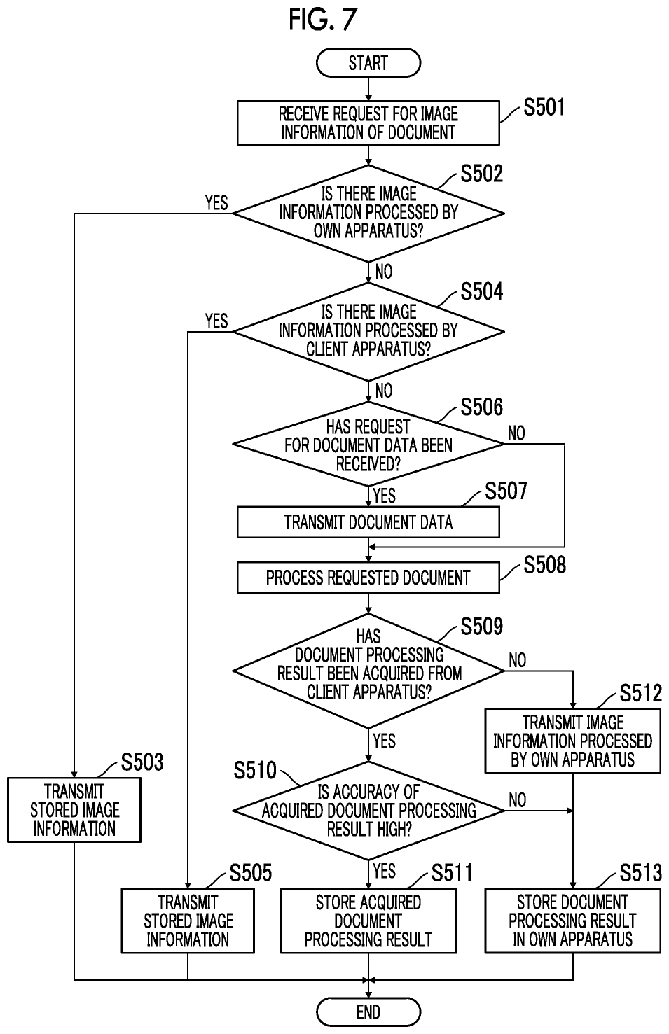

FIG. 7 is a flowchart showing a process procedure in which the server apparatus 10 manages documents.

In the flowchart of FIG. 7, the request reception unit 111 shown in FIG. 5 receives a request for image information for displaying a document as a thumbnail image from information that is transmitted from the client apparatus 20 and received by the reception unit 13a (step S501). The processing result management unit 112 retrieves whether or not the requested image information that is document image information processed by the server apparatus is stored in the processing result storage unit 118 based on the request received by the request reception unit 111 (step S502). The requested image information is, for example, document image information requested by the client apparatus 20a and displayed on the display unit 25 of the client apparatus 20a.

In a case where the document image information processed by the server apparatus is stored in the processing result storage unit 118 in step S502 (YES in step S502), the processing result management unit 112 extracts the image information processed by the server apparatus from the processing result storage unit 118 and transmits the image information to the client apparatus 20 having made the request via the transmission unit 13b (step S503), and the process is finished. In this case, attribute information of the requested document may be transmitted together with the requested image information.

In a case where the image information of the document processed by the server apparatus is not stored in the processing result storage unit 118 in step S502 (NO in step S502), the processing result management unit 112 retrieves whether or not the requested image information that is document image information processed by another client apparatus different from the client apparatus having made the request is stored in the processing result storage unit 118 based on the request received by the request reception unit 111 (step S504).

In a case where the document image information processed by the other client apparatus is stored in the processing result storage unit 118 in step S504 (YES in step S504), the processing result management unit 112 extracts the image information processed by the other client apparatus from the processing result storage unit 118 and transmits the image information to the client apparatus 20 having made the request via the transmission unit 13b (step S505), and the process is finished.

In a case where the document image information processed by the other client apparatus is not stored in the processing result storage unit 118 in step S504 (NO in step S504), the request reception unit 111 determines whether or not a request for document data of a document of which image information is requested has been received based on information that is transmitted from the client apparatus 20 and received by the reception unit 13a (step S506).

In a case where the request for document data has not been received in step S506 (NO in step S506), the document data is not transmitted instead of the document image information, and the process proceeds to step S508.

In a case where the document data request is received in step S506 (YES in step S506), the processing result management unit 112 extracts the requested document data from the document data storage unit 117 based on the request received by the request reception unit 111, and transmits the document data to the client apparatus 20 having made the request via the transmission unit 13b (step S507). Based on the request received by the request reception unit 111, the document processing unit 114 extracts document data of the document of which image information or document data is requested from the document data storage unit 117 and processes the document data (step S508). The document data is transmitted to the client apparatus 20 and the document is processed by the server apparatus 10, and thus a highly accurate processing result is ensured.

Next, the processing result acquisition unit 115 determines whether or not a document processing result in the client apparatus 20 has been acquired based on information that is transmitted from the client apparatus 20 and received by the reception unit 13a (step S509). For example, in a case where the document data has been transmitted to the client apparatus 20a, the processing result acquisition unit 115 determines whether or not a processing result of the document of which the document data has been transmitted has been acquired from the client apparatus 20a.

In a case where the document processing result has been acquired from the client apparatus 20 (YES in step S509), the processing result determination unit 116 determines whether or not an accuracy of the document processing result in the client apparatus 20 acquired by the processing result acquisition unit 115 is high (step S510). In a case where a document processing result in the client apparatus 20a matches a document processing result in the client apparatus 20b acquired separately therefrom with respect to the same document, the processing result determination unit 116 in the present exemplary embodiment determines that the accuracy of the document processing result in the client apparatus 20 is high.

In a case where the accuracy of the document processing result in the client apparatus 20 is not high in step S510 (NO in step S510), the document processing result in the client apparatus 20 is not stored in the processing result storage unit 118, and the process proceeds to step S513.

In a case where the accuracy of the document processing result in the client apparatus 20 is high in step S510 (YES in step S510), the processing result storage unit 118 stores the document processing result acquired from the client apparatus 20 (Step S511), the process is finished.

In a case where the document processing result has not been acquired from the client apparatus 20 in step S509 (NO in step S509), the transmission unit 13b transmits image information as a document processing result in the document processing unit 114 to the client apparatus 20 having made the request (step S512). The processing result storage unit 118 stores the document processing result in the document processing unit 114 (step S513), and the process is finished.

Through the above processes, the server apparatus 10 can ensure a highly accurate document processing result while reducing a load due to unnecessary document processing. The server apparatus 10 acquires a document processing result in a certain client apparatus 20 and stores the document processing result into the processing result storage unit 118, and transmits the document processing result in a case where the document processing result in the certain client apparatus 20 is requested from another client apparatus 20 different from the certain client apparatus 20. A document processing result in one client apparatus 20 is shared, and thus it is possible to prevent repeated processing on the same document and thus to improve the efficiency of document processing.

Document Display Process in Client Apparatus 20

Next, a document display process in the client apparatus 20 will be described with reference to FIGS. 2, 4, 6, and 8. Here, as an example, a case where image information of a document located in the display region 310 is not stored in the processing result storage unit 217 will be described.

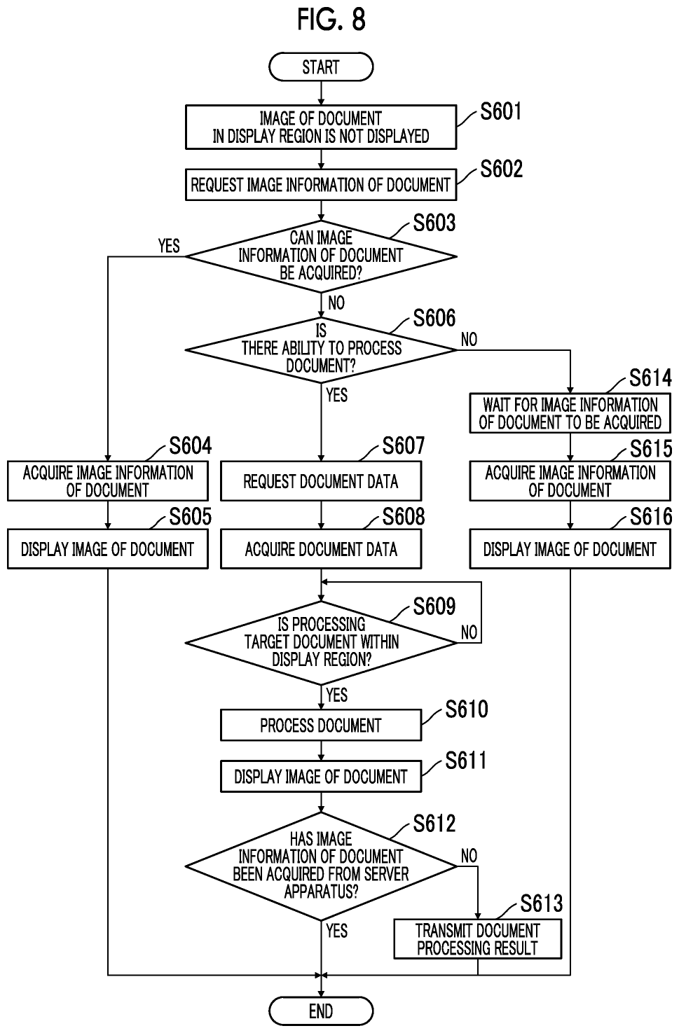

FIG. 8 is a flowchart showing a process procedure in which the client apparatus 20 displays a document.

In the flowchart of FIG. 8, an event occurs in which an image of a document in the display region 310 is not displayed on the display unit 25 shown in FIG. 4 (step S601).

The event occurs in, for example, a thumbnail image in which the document icon 261 and the icon 260 using thumbnail images are designated by a user and displayed. In a case where image information of the display document icon 261a shown in FIG. 4 is not stored in the processing result storage unit 217, display of the display document icon 261a using a thumbnail image may be delayed. The display of the display document icon 261a is delayed, for example, in a case where the display region 310 transitions and a certain document icon 261 changes from the non-display document icon 261b to the display document icon 261a based on details determined by the operation determination unit 211 and a case where the new operation screen 250 is displayed.

Next, the communication processing unit 218 requests image information regarding the image of the document that is not displayed to the server apparatus 10 via the communication unit 23 based on details related to the display on the operation screen 250 controlled by the display control unit 215 (step S602). The communication processing unit 218 may request attribute information of the document together with the image information.

The communication processing unit 218 processes information from the server apparatus 10 acquired via the communication unit 23, and determines whether or not the requested image information of the document can be immediately acquired (step S603). For example, in a case where the image information of the document from the server apparatus 10 cannot be acquired even though a predefined time has elapsed after requesting the image information of the document or a case where the communication processing unit 218 has been notified that processing of a document in another different client apparatus 20 has already been received by the server apparatus 10 and that the number of documents to be processed received by the server apparatus 10 is larger than a predefined number, the communication processing unit 218 in the present exemplary embodiment determines that the requested image information of the document cannot be obtained immediately.

In a case where the image information of the document requested to the server apparatus 10 can be immediately acquired in step S603 (YES in step S603), the communication processing unit 218 acquires the requested image information of the document from the server apparatus 10 via the communication unit 23 (step S604). The display control unit 215 displays the image of the document on the display unit 25 based on the image information of the document acquired from the communication processing unit 218 (step S605), and the process is finished.

In a case where the image information of the document requested to the server apparatus 10 cannot be immediately acquired in step S603 (NO in step S603), the processing ability determination unit 212 determines whether or not the client apparatus has the ability to process the document of which display is requested based on details determined by the operation determination unit 211 (step S606). The ability is based on the type of client apparatus such as a personal computer or smartphone, an operating system (OS), and the presence or absence of processing ability. The ability may be based on a usage status for the client apparatus.

In a case where the client apparatus has the ability to process the document in step S606 (YES in step S606), the communication processing unit 218 requests document data of the document of which image information has been requested to the server apparatus 10 via the communication unit 23 based on the details determined by the processing ability determination unit 212 (step S607). The communication processing unit 218 acquires the requested document data of the document from the server apparatus 10 via the communication unit 23 (step S608). The processing target determination unit 213 determines whether or not a document processing target in the client apparatus is a document in the display region 310 (step S609). The target is, for example, a document corresponding to the document icon 261 displayed as a thumbnail image, a document stored in a file corresponding to the tray icon 262 or the folder icon 263 selected by the user.

In a case where the document processing target in the client apparatus is not in the display region 310 in step S609 (NO in step S609), the document is not processed and the document processing unit 214 waits for a target to be within the display region 310. In a case where a document that is being processed by the client apparatus is changed from the display region 310 to the non-display region 320 according to the user's instruction, the document processing is stopped.

In a case where the document processing target is within the display region 310 in step S609 (YES in step S609), the document processing unit 214 extracts document data of the document processing target in the client apparatus from the document data storage unit 216 based on details determined by the processing target determination unit 213, and processes the document (step S610). The document processing unit 214 in the present exemplary embodiment performs a process of converting image information included in the document data into a format that can be viewed on the display unit 25, and a process of extracting attribute information from the document data.

Next, the display control unit 215 displays the image of the document on the display unit 25 based on a document processing result in the document processing unit 214 (step S611). The communication processing unit 218 determines whether or not the requested image information of the document has been acquired from the server apparatus 10 via the communication unit 23 (step S612).

In a case where the requested image information of the document has been acquired from the server apparatus 10 (YES in step S612), the process is finished.

In a case where the requested image information of the document has not been acquired from the server apparatus 10 (NO in step S612), the communication processing unit 218 transmits a requested document processing result to the server apparatus 10 via the communication unit 23 based on the document processing result in the document processing unit 214 (step S613), and the process is finished.

In a case where the client apparatus does not have the ability to process the document in step S606 (NO in step S606), the communication processing unit 218 waits for the communication unit 23 to receives and acquire the image information of the document requested by the server apparatus 10. (Step S614). The communication processing unit 218 acquires the requested image information of the document from the server apparatus 10 via the communication unit 23 (step S615). The display control unit 215 displays the image of the document on the display unit 25 based on the image information of the document acquired from the communication processing unit 218 (step S616), and the process is finished.

Through the above processes, the client apparatus 20 can reduce a load due to unnecessary document processing and also reduce a waiting time felt by a user until a document processing result is displayed on the operation screen 250.

In the above example, in a case where an event occurs in which a thumbnail image of a document in the display region 310 is not displayed on the display unit 25, a document processing result in the server apparatus 10 or a document processing result in the client apparatus is provided to a user, but the present exemplary embodiment is not limited thereto. A document processing result requested by the client apparatus 20 may already be stored in a separate apparatus different from the server apparatus 10. The separate apparatus may be, for example, another server apparatus different from the server apparatus 10 configuring an existing system different from the information processing system 1 in the present exemplary embodiment together with the client apparatus 20. In a case where the client apparatus 20 cannot immediately acquire a document processing result from the server apparatus 10, the client apparatus 20 may acquire the processing result from a separate apparatus without performing requested document processing in the client apparatus. According to this aspect, existing information can be effectively utilized and unnecessary document processing can be omitted.

In the above-described example, in a case where an event occurs in which a thumbnail image of a document in the display region 310 is not displayed on the display unit 25, image information regarding an image or document data of the document that is not displayed is requested to the server apparatus 10 or the like, but the present exemplary embodiment is not limited thereto. The client apparatus 20 may request the image information regarding the image of the document to the server apparatus 10 in a case where the event that the thumbnail image of the document in the display region 310 is not actually displayed has not occurred. For example, in a case where the client apparatus 20 receives an instruction for the icon 260 corresponding to a file in which a document displayed as a thumbnail image is stored, image information or the like regarding a thumbnail image of a document that is not stored in the client apparatus is requested to the server apparatus or the like. In this aspect, the processing target determination unit 213 determines whether or not the document stored in the file is a document processing target in the client apparatus based on a display position of the icon 260 corresponding to the file.

Settings Related to Document Processing in the Client Apparatus 20

In the above-described example, whether or not a document is processed by the client apparatus is determined based on the processing ability that can be realized by the client apparatus 20, but may be determined based on the processing ability that accompanies an instruction from a user.

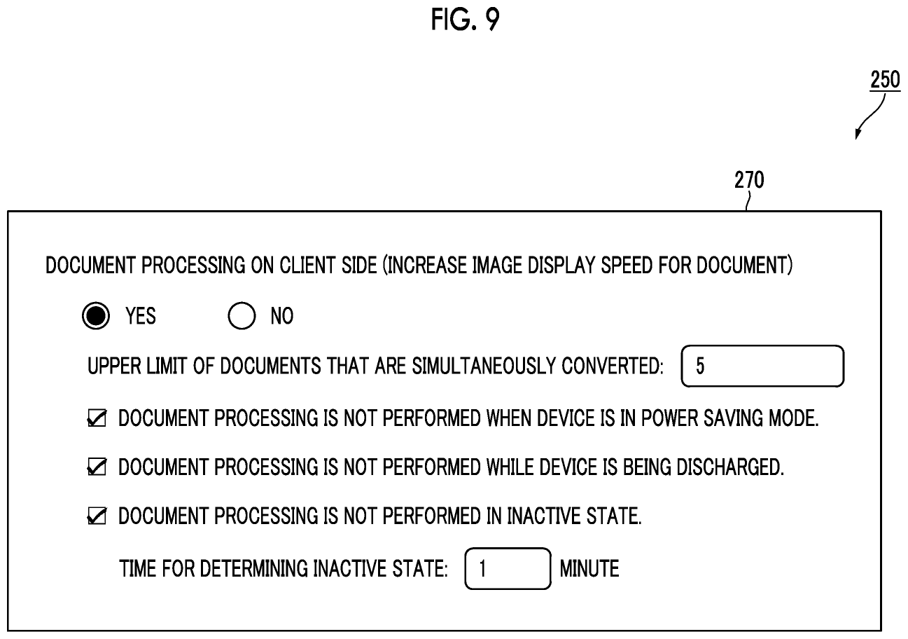

As an example, a screen in which a user can set document processing in the client apparatus 20 will be described with reference to FIG. 9.

FIG. 9 is a diagram showing an example of a setting screen 270 for receiving settings related to document processing in the client apparatus 20 according to the present exemplary embodiment.

As shown in FIG. 9, on the operation screen 250, the setting screen 270 in which a user sets “Yes” or “No” for document processing in the client apparatus is displayed. The setting screen 270 is displayed, for example, in a case where an icon (not shown) related to a setting on the operation screen 250 is operated, a case where software for providing the operation screen 250 is used for the first time, or a case where an event in which the client apparatus 20 is required to process a document occurs for the first time.

The setting screen 270 may have an image for receiving a user's instruction for setting an upper limit of the number of documents to be processed simultaneously by the client apparatus 20, in addition to the presence or absence of document processing in the client apparatus 20. The setting screen 270 may have an image for receiving a user's instruction for setting conditions regarding the presence or absence of document processing in the client apparatus 20. The conditions include usage statuses for the client apparatus 20, such as a power saving mode for suppressing power consumption, a discharge state in which power is consumed without power supply because the apparatus is not connected to a power source, and an inactive state in which a user's operation is not performed for a predefined time. A user may set a time for determining that the client apparatus is inactive.

A user sets whether or not document processing is performed by the client apparatus 20 according to a usage status for the client apparatus 20, and thus it is possible to avoid consumption of the resources of the client apparatus 20 due to processing unnecessary for a user.

The processes performed by the server apparatus 10 or the client apparatus 20 in the present exemplary embodiment are prepared as a program such as application software. The program may be provided not only by communication means but also by storing the program in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a server apparatus that processes a document; and a client apparatus that provides a user with a result of processing the document,
wherein processing of the document is performed in the server apparatus and the client apparatus in response to an instruction from the user,
in a case where the processing of the document in the client apparatus is completed faster than the processing of the document in the server apparatus, a result of the processing of the document is transmitted from the client apparatus to the server apparatus, and
in a case where an instruction for the document is given by another client apparatus different from the client apparatus, the result of the processing of the document is transmitted from the server apparatus to the other client apparatus.

2. The information processing system according to claim 1,
wherein the processing is a process of converting image information included in the document into a viewable format.

3. The information processing system according to claim 2,
wherein the processing is a process of extracting attribute information from the document.

4. The information processing system according to claim 1,
wherein, in a case where the result of the processing of the document transmitted by the client apparatus satisfies a predefined condition, the server apparatus stores the result of the processing.

5. The information processing system according to claim 4,
wherein the server apparatus stores the result of the processing based on comparison between the result of the processing of the document transmitted by the client apparatus and a result of processing of the document transmitted by another client apparatus different from the client apparatus.

6. The information processing system according to claim 1,
wherein the client apparatus determines whether or not to process the document in the client apparatus according to an ability of the client apparatus to process the document.

7. The information processing system according to claim 6,
wherein the ability of the client apparatus to process the document is an ability based on at least one of a configuration or a setting of the client apparatus.

8. The information processing system according to claim 6,
wherein the ability of the client apparatus to process the document is an ability based on a usage status of the user for the client apparatus.

9. The information processing system according to claim 1,
wherein the processing of the document in the client apparatus is performed with priority over other documents different from the document based on an instruction from the user.

10. The information processing system according to claim 9,
wherein the processing of the document displayed in a display region of the client apparatus is performed by the client apparatus with priority over a document not displayed in the display region through an operation of the user.

11. The information processing system according to claim 10,
wherein, in a case where the processing of the document not displayed in the display region is performed by the client apparatus, the processing is stopped.

12. The information processing system according to claim 1,
wherein, in a case where a result of processing of the document is stored in a separate apparatus different from the server apparatus, the client apparatus does not process the document and acquires the result of the processing performed by the separate apparatus.

13. An information processing method comprising:
transmitting the document to a client apparatus that provides a result of processing of the document to a user and of processing the document;
acquiring a result of processing of the document in the client apparatus; and
in a case where an instruction for the document is given by another client apparatus different from the client apparatus, transmitting the result of the processing of the document in the client apparatus from the computer to the other client apparatus.

14. A non-transitory computer readable medium storing a program causing a computer that provides a result of processing of a document to a user to realize:
a function of acquiring the document from a server apparatus that stores the document;
a function of processing the document in response to an instruction from the user and providing a result of the processing to the user;
a function of converting image information included in the document into a viewable format as the processing of the document;
a function of extracting attribute information from the document as the processing of the document; and
a function of, in a case where processing of the document in the computer is completed faster than the processing of the document in the server apparatus, transmitting the result of the processing in the computer to the server apparatus.

15. The non-transitory computer readable medium storing the program according to claim 14, causing the computer to further realize:
a function of determining whether or not the computer processes the document according to an ability of the computer to process the document.
